(19) United States
(12) Patent Application Publication
(10) Pub. No.: US 2026/0213227 A1
(43) Pub. Date: Jul. 23, 2026

(54) GAS DIFFUSION COMPOSITE MATERIAL FOR FUEL CELLS, AND POLYMER ELECTROLYTE FUEL CELL

(71) Applicant: KYUSHU UNIVERSITY, NATIONAL UNIVERSITY CORPORATION, Fukuoka (JP)

(72) Inventors: Makoto YOSHIKAWA, Fukuoka (JP); Zhiyun NODA, Fukuoka (JP); Masahiro YASUTAKE, Fukuoka (JP); Junko MATSUDA, Fukuoka (JP); Kazunari SASAKI, Fukuoka (JP)

(21) Appl. No.: 19/133,511

(22) PCT Filed: Mar. 15, 2024
(86) PCT No.: PCT/JP2024/010185

§ 371 Date: May 28, 2025

(30) Foreign Application Priority Data
Mar. 16, 2023 (JP) 2023-042109

(51) Int. Cl. H01M 8/0245; H01M 8/0234; H01M 8/0239; H01M 8/10; H01M 8/1004

(52) U.S. Cl. CPC H01M 8/0245; H01M 8/0234; H01M 8/0239; H01M 8/1004; H01M 2008/1095

(57) ABSTRACT

Provided are a gas diffusion composite material for fuel cells, which is a thin layer and has reduced electrical resistance such as contact resistance, and a polymer electrolyte fuel cell including the gas diffusion composite material. Disclosed is a gas diffusion composite material for fuel cells, the gas diffusion composite material including: a porous substrate sheet including a conductive material; and a microporous carbon layer containing a particulate and/or fibrous carbon material and a water-repellent resin. The gas diffusion composite material has a structure, e.g., in which at least one surface of the porous substrate sheet is coated with the microporous carbon layer.

### REFERENCE TO RELATED APPLICATION

The present application claims the benefit of priority from the Japanese Patent Application filed on Mar. 16, 2023 (Japanese Patent Application No. 2023-42109). Priority is expressly claimed to the foregoing patent application, the entire disclosure of which is incorporated herein by reference for all purposes. The entire contents of the Japanese patent application are incorporated herein as reference.

The present invention relates to: a gas diffusion composite material for fuel cells; and a polymer electrolyte fuel cell.

### TECHNICAL FIELD

### Background Art

A polymer electrolyte fuel cell (PEFC) is configured with, as a basic unit, a structure in which a PEFC single cell is sandwiched between two separators having a gas flow path. The PEFC single cell includes: a membrane electrode assembly (MEA) including an electrolyte membrane and electrodes (an anode and a cathode) stacked on both surfaces of the electrolyte membrane; and gas diffusion layers (GDL) stacked on both surfaces of the membrane electrode assembly.

The gas diffusion layer of the PEFC is required to have high gas diffusibility for diffusing a gas supplied from the separator into an electrode catalyst layer, a high drainage property for discharging water generated by an electrochemical reaction to the separator, and high conductivity for extracting generated current. Thus, in the widely used gas diffusion layer of the PEFC, a microporous layer (MPL) including a carbon powder and a fluororesin is formed on a surface of a carbon sheet including a carbon fiber as a substrate layer. The MPL is a layer including a porous composite material of a conductive carbon material and a water-repellent fluororesin, the carbon material forms a conductive network, and the fluororesin serves as an adhesive and exhibits water repellency.

As described above, the GDL is required to have high gas diffusibility for diffusing the gas supplied from the separator into the electrode catalyst layer, and when the gas diffusibility is insufficient, power generation performance particularly in a high current density region is deteriorated. In the PEFC, the thinner the unit cell, the better the integration property; however, the thickness of the GDL is about from 150 μm to 1 mm, and a ratio of the GDL in the total thickness of the PEFC single cell is large. Thus, if the gas diffusion layer can be thinned, the PEFC single cell can be thinned, the integration property is improved and the output is expected to be improved.

For example, Patent Document 1 reports a fuel cell in which the thickness of a gas diffusion layer is reduced as compared with the known case. In the technique of Patent Document 1, by reducing the thickness of the gas diffusion layer with respect to a rib width of a separator, the gas diffusibility in a high current density region is improved, and power generation performance is improved.

The present inventors have reported a porous metal gas diffusion layer including a metal porous sheet in Patent Document 2. As the porous metal sheet, a metal mesh sheet including metal Sn, a Sn alloy, or stainless steel, or a metal fiber sheet including metal Ti or a Ti alloy is used.

### CITATION LIST

### Patent Documents

Patent Document 1: JP 2022-11735 A
Patent Document 2: JP 2022-145670 A

### SUMMARY OF INVENTION

### Technical Problem

The gas diffusion layer of Patent Document 1 has self-standing properties by using a special carbon fiber as a constituent material, and the thickness of the gas diffusion layer of Patent Document 1 is about 150 μm as thinning limitation.

The porous metal gas diffusion layer of Patent Document 2 can have a thickness of about 30 μm and is useful for thinning the PEFC single cell; however, there is room for improvement in terms of electrical resistance derived from a metal gas diffusion layer, such as contact resistance.

Under such circumstances, an object of the present invention is to provide a gas diffusion composite material for fuel cells, which is a thin layer and has reduced electrical resistance such as contact resistance, and a polymer electrolyte fuel cell including the gas diffusion composite material.

### Solution to Problem

As a result of intensive studies to solve the above issues, the present inventors have found that the following meets the objects and have completed the present invention.

That is, the present invention relates to the following aspects.
<1> A gas diffusion composite material for fuel cells, the gas diffusion composite material including:
a porous substrate sheet including a conductive material; and
a microporous carbon layer containing a particulate and/or fibrous carbon material and a water-repellent resin,
wherein
the porous substrate sheet has a thickness of 3 μm or more and 150 μm or less, and
the gas diffusion composite material has any one of the following structures (A) to (E):
structure (A): a structure in which one surface of the porous substrate sheet is coated with the microporous carbon layer,
structure (B): a structure in which both surfaces of the porous substrate sheet are coated with the microporous carbon layer,
structure (C): a structure in which the microporous carbon layer covers one surface of the porous substrate sheet, and a part of the microporous carbon layer penetrates into the porous substrate sheet,
structure (D): a structure in which the microporous carbon layer covers one surface of the porous substrate sheet, a part of the microporous carbon layer penetrates into the porous substrate sheet, and the microporous carbon layer reaches from one surface to the opposite surface of the porous substrate sheet,
structure (E): a structure in which the entire porous substrate sheet is embedded in the microporous carbon layer.
<2> The gas diffusion composite material according to <1>, wherein the porous substrate sheet has a thickness of 5 μm or more and 100 μm or less.
<3> The gas diffusion composite material according to <1> or <2>, wherein a total thickness of the gas diffusion composite material is 3 μm or more and 150 μm or less.
<4> The gas diffusion composite material according to any one of <1> to <3>, wherein the total thickness of the gas diffusion composite material is 20 μm or more and 100 μm or less.
<5> The gas diffusion composite material according to any one of <1> to <4>, wherein a form of the porous substrate sheet is a mesh sheet, a punching sheet, or an expanded sheet.
<6> The gas diffusion composite material according to any one of <1> to <5>, wherein a material of the porous substrate sheet is a carbon material.
<7> The gas diffusion composite material according to any one of <1> to <5>, wherein the porous substrate sheet is a carbon mesh.
<8> The gas diffusion composite material according to any one of <5> to <7>, wherein the gas diffusion composite material has any one of the structures (C) to (E).
<9> The gas diffusion composite material according to <7>, wherein the gas diffusion composite material has the structure (C).
<10> The gas diffusion composite material according to any one of <1> to <5>, wherein the porous substrate sheet includes a metal material.
<11> The gas diffusion composite material according to any one of <1> to <5>, wherein the porous substrate sheet is a stainless steel mesh.
<12> The gas diffusion composite material according to <11>, wherein the gas diffusion composite material has any one of the structures (C) to (E).
<13> The gas diffusion composite material according to <11>, wherein the gas diffusion composite material has the structure (D).
<14> A gas diffusion composite material for fuel cells, the gas diffusion composite material including:
a porous substrate sheet including a non-conductive material; and
a microporous carbon layer containing a particulate and/or fibrous carbon material and a water-repellent resin,
wherein the porous substrate sheet has a thickness of 3 μm or more and 150 μm or less, and the gas diffusion composite material has the following structure (D) or (E):
structure (D): a structure in which the microporous carbon layer covers one surface of the porous substrate sheet including the non-conductive material, a part of the microporous carbon layer penetrates into the porous substrate sheet including the non-conductive material, and the microporous carbon layer reaches from one surface to the opposite surface of the porous substrate sheet including the non-conductive material,
structure (E): a structure in which the entire porous substrate sheet is embedded in the microporous carbon layer.
<15> The gas diffusion composite material for fuel cells according to any one of <1> to <14>, wherein the particulate and/or fibrous carbon material included in the microporous carbon layer is carbon black, a carbon nanotube, and a mixture thereof.
<16> A polymer electrolyte fuel cell including:
a membrane electrode assembly including a polymer electrolyte membrane, a cathode catalyst layer bonded to one surface of the polymer electrolyte membrane, and an anode catalyst layer bonded to the other surface of the polymer electrolyte membrane;
a pair of gas diffusion layers each stacked on a corresponding one of the cathode catalyst layer and the anode catalyst layer; and
a pair of separators sandwiching the membrane electrode assembly with the gas diffusion layer interposed therebetween,
wherein at least one of the pair of gas diffusion layers is the gas diffusion composite material for fuel cells described in any one of <1> to <15>.

### Advantageous Effects of Invention

According to the present invention, there are provided a gas diffusion composite material for fuel cells, which is a thin layer and has reduced electrical resistance such as contact resistance, and a polymer electrolyte fuel cell including the gas diffusion composite material.

### BRIEF DESCRIPTION OF DRAWINGS

FIG. 1 is a schematic structural view of a polymer electrolyte fuel cell.

FIG. 2 is a schematic view of a membrane electrode assembly including a known gas diffusion layer.

FIG. 3 is a schematic view of a gas diffusion composite material for fuel cells of the present invention ((A) MPL is stacked on one surface of a porous substrate sheet; (B) the MPLs are stacked on both surfaces of the porous substrate sheet; (C) the porous substrate sheet is partially embedded in the MPL (does not reach a back surface); (D) the MPL is partially embedded in the porous substrate sheet (reaches the back surface), and (E) the porous substrate sheet is entirely embedded in the MPL).

FIG. 4 is a microstructural photograph of a surface of a gas diffusion member 1 (stainless steel mesh sheet, SUS316 977 mesh).

FIG. 5 is a microstructural photograph of a surface of a gas diffusion member 2 (MPL composite stainless steel mesh).

FIG. 6 is a microstructural photograph of a cross section of the gas diffusion member 2 (MPL composite stainless steel mesh).

FIG. 7 is an observation result of a microstructure of a surface of a gas diffusion member 3 (gas diffusion layer with MPL (reference example)).

FIG. 8 is an observation result of a microstructure of a cross section of the gas diffusion member 3 (gas diffusion layer with MPL (reference example)).

FIG. 9 is an appearance photograph of a gas diffusion member 5 (MPL composite carbon mesh).

FIG. 10 is IV characteristics of a PEFC single cell using the gas diffusion members 1 to 3.

FIG. 11 is the IV characteristics of the PEFC single cell using the gas diffusion members 4 and 5.

FIG. 12 is the IV characteristics of the PEFC single cell using the gas diffusion member 6.

### DESCRIPTION OF EMBODIMENTS

Hereinafter, the present invention will be described in detail with reference to examples and the like, but the present invention is not limited to the examples and the like set forth below and the examples and the like can be freely modified and implemented without departing from the gist of the present invention. Note that, as used herein, “from . . . to . . . ” or “ . . . to . . . ” is used as an expression including numerical values or physical quantities before and after the “to”.

### 1. Gas Diffusion Composite Material for Fuel Cells

The present invention relates to a gas diffusion composite material for fuel cells (hereinafter, may be referred to as “the gas diffusion composite material of the present invention”), including: a porous substrate sheet including a conductive material; and a microporous carbon layer containing a particulate and/or fibrous carbon material and a water-repellent resin, wherein the porous substrate sheet has a thickness of 3 μm or more and 150 μm or less, and the gas diffusion composite material has any one of the following structures (A) to (E).
Structure (A): a structure in which one surface of the porous substrate sheet is coated with the microporous carbon layer.
Structure (B): a structure in which both surfaces of the porous substrate sheet are coated with the microporous carbon layer.
Structure (C): a structure in which the microporous carbon layer covers one surface of the porous substrate sheet, and a part of the microporous carbon layer penetrates into the porous substrate sheet.
Structure (D): a structure in which the microporous carbon layer covers one surface of the porous substrate sheet, a part of the microporous carbon layer penetrates into the porous substrate sheet, and the microporous carbon layer reaches from one surface to the opposite surface of the porous substrate sheet.
Structure (E): a structure in which the entire porous substrate sheet is embedded in the microporous carbon layer.

Details of the structures (A) to (E) will be described later in “1-3. Arrangement of porous substrate sheet and microporous carbon layer”.

The gas diffusion composite material of the present invention is suitable as a gas diffusion layer of a polymer electrolyte fuel cell.

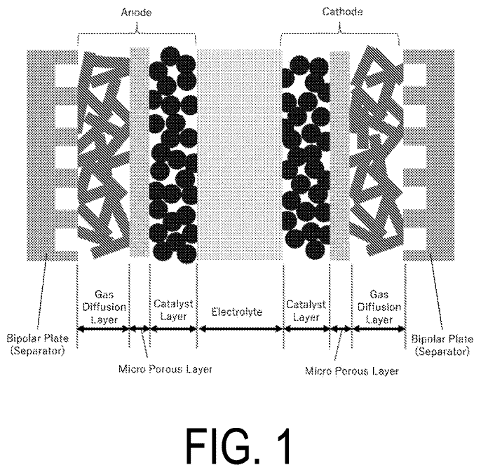

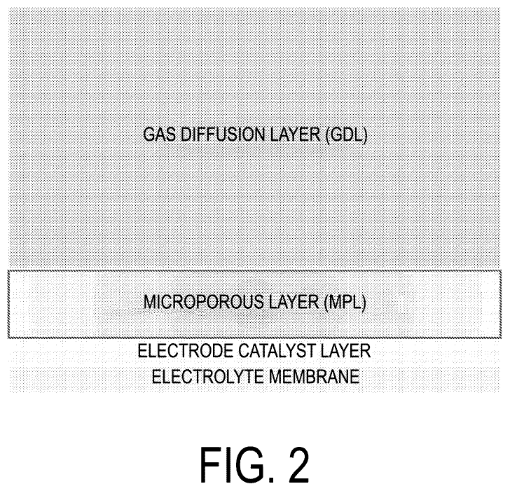

Hereinafter, the role of the gas diffusion composite material (gas diffusion layer) in the polymer electrolyte fuel cell will be described with reference to FIGS. 1 and 2.

FIG. 1 is a conceptual diagram showing a typical configuration of the polymer electrolyte fuel cell. Hydrogen is supplied to a fuel electrode (anode) in the polymer electrolyte fuel cell, and protons (H⁺) and electrons are generated as a result of (Reaction 1) 2H₂→4H⁺+4e⁻. The generated protons are supplied to an air electrode (cathode) via a polymer electrolyte membrane, and the generated electrons are supplied to the air electrode (cathode) via an external circuit (not shown). The protons and the electrons react with oxygen to produce water in accordance with (Reaction 2) O₂+4H⁺+4e⁻→2H₂O. The electrochemical reactions at the fuel electrode (anode) and the air electrode (cathode) generate a potential difference between both electrodes.

FIG. 2 shows a schematic view of a membrane electrode assembly including a known gas diffusion member.

Main functions required for the gas diffusion member of PEFC include moisturization of a polymer electrolyte membrane (about 10 μm in thickness), drainage from an electrode catalyst layer, electron conduction between the electrode catalyst layer and a separator, and gas transport. As a known gas diffusion member, a carbon fiber-based gas diffusion layer (GDL) and a microporous layer (MPL), which is a layer having finer pores, deposited on a surface of the carbon fiber-based gas diffusion layer in contact with an electrode catalyst layer in order to enhance current collectability and water retainability are widely used.

In particular, in the PEFC having a thickness of about 1 mm, two carbon fiber-based gas diffusion layers having a thickness of about 200 μm are used adjacent to both electrodes; however, there are problems such as reduction in mechanical strength due to thinning and high cost.

On the other hand, the gas diffusion composite material of the present invention has a structure in which a microporous carbon layer containing a particulate and/or fibrous carbon material and a water-repellent resin is supported by a porous substrate sheet (for example, a conductive porous substrate sheet formed from metal or carbon) having excellent mechanical strength and a thickness of 3 μm or more and 150 μm or less. By having such a structure, the gas diffusion composite material of the present invention has sufficient mechanical strength and electrical conductivity derived from the porous substrate sheet, and electrical conductivity and water repellency derived from the microporous carbon layer, and thus, the total thickness of the gas diffusion composite material can be reduced to 150 μm or less (preferably 100 μm or less, 60 μm or less).

By disposing the gas diffusion composite material of the present invention including the microporous carbon layer having excellent current collectability and low contact resistance on the surface, overvoltage is reduced and power generation characteristics (IV characteristics) are excellent as compared with the case of using only a porous substrate sheet having no microporous layer.

A basic configuration of the polymer electrolyte fuel cell is a unit cell, and the polymer electrolyte fuel cell is usually used as a fuel cell stack by stacking a determined number of unit cells according to the power generation performance of a unit cell. Therefore, in place of a known gas diffusion member (carbon fiber-based gas diffusion layer with MPL), the gas diffusion composite material of the present invention including a porous substrate sheet formed from a conductive material and a microporous carbon layer containing a particulate and/or fibrous carbon material and a water-repellent resin is used as a gas diffusion member for a fuel cell, and disposed between an electrode catalyst layer and a separator, whereby the thickness of the fuel cell stack can be significantly reduced.

The gas diffusion composite material of the present invention can be disposed on one or both of the cathode side and the anode side.

Hereinafter, components of the gas diffusion composite material for fuel cells of the present invention will be described.

In the polymer electrolyte fuel cell according to the present invention, components other than the gas diffusion composite material for fuel cells of the present invention are the same as those of known polymer electrolyte fuel cells, and thus description thereof will be omitted.

### (1-1. Porous Substrate Sheet)

The porous substrate sheet included in the gas diffusion composite material of the present invention is a sheet-like member having a plurality of through-holes and including a conductive material.

The form of the porous substrate sheet is not limited as long as the effect of the present invention is exhibited, and examples thereof include a mesh sheet, a punching sheet, and an expanded sheet.

In the present specification, the “mesh sheet” is a sheet-like member formed by knitting thin wires of a constituent material, and a space between the knitted thin wires is a penetration space (through-hole) penetrating a mesh in a thickness direction. The thickness of the mesh sheet and the hole diameter, hole density, and size of the through-hole may be appropriately designed within a range in which the strength can be maintained without impairing the object of the present invention.

In the present specification, the “punching sheet” means a sheet-like member having a large number of through-holes, manufactured by punching a sheet (band-shaped body) of a constituent material with a punching device. The thickness of the punching sheet and the hole diameter, hole density, and size of the through-hole may be appropriately designed within a range in which the strength can be maintained without impairing the object of the present invention.

In the present specification, the “expanded sheet” is a sheet-like member produced by making a cut in a sheet of a constituent material, expanding the cut, and forming the cut into a rhombus shape, a tortoise-shell shape, or the like, and a portion where the cut is expanded and formed into a rhombus shape, a tortoise-shell shape, or the like is a penetration space (through-hole) penetrating an expand in the thickness direction. The hole diameter and density of the through-hole of the expanded sheet may be appropriately designed within a range in which the strength can be maintained without impairing the object of the present invention according to the hole diameter of the through-hole.

Among the forms of the porous substrate sheet, a mesh sheet is preferable.

The mesh sheet has a woven fabric structure. Examples of the woven fabric structure include plain weave, twill weave, plain dutch weave, and twilled dutch weave.

The “plain weave” is a method of weaving by alternately crossing vertical lines and horizontal lines one by one. The “twill weave” is a method of weaving by crossing vertical lines and horizontal lines at intervals of several lines. “Plain dutch weave” is a method of weaving lines like a tatami facing. “Twilled dutch weave” is a method in which a twill weave is applied to a plain dutch weave.

The number of lines (that is, linear material) in the unit area of the mesh sheet tends to increase in the order of “plain weave <twill weave <plain dutch weave <twill dutch weave”.

As the number of lines in the unit area of the mesh sheet increases, flatness of the surface of the mesh sheet is improved. Improvement in the flatness of the surface of the mesh sheet can increase a contact area of the gas diffusion member with respect to other components (for example, an electrode catalyst layer and a separator) in the fuel cell, and the increase in the contact area between the components can contribute to improvement in electrical connectivity between the components.

The thickness of the porous substrate sheet is 3 μm or more and 150 μm or less, and preferably 5 μm or more and 100 μm or less, 20 μm or more and 100 μm or less, 5 μm or more and 60 μm or less, or 20 μm or more and 60 μm or less. With such a thickness, mechanical strength can be imparted to the gas diffusion composite material of the present invention, and self-standing properties can be provided even when the microporous carbon layer is provided.

The thickness of the porous substrate sheet can be measured by, for example, a micrometer.

In the gas diffusion composite material of the present invention, a material having both sufficient durability and electron conductivity under operating conditions of the PEFC is selected as a constituent material of the porous substrate sheet. Specifically, a metal material and a carbon material are selected as a constituent material of the porous substrate sheet.

In the present specification, the operating condition of the PEFC includes both a cathode condition and an anode condition of the PEFC. The cathode condition of the PEFC is a condition in the cathode during normal operation of the PEFC and means a condition in which a temperature is about room temperature to about 150° C. and a gas containing oxygen such as air is supplied (oxidizing atmosphere), and the anode condition is a condition in the anode during normal operation of the PEFC and means a condition in which a temperature is about room temperature to about 150° C. and a fuel gas containing hydrogen is supplied (reducing atmosphere).

The metal material is not limited as long as the object of the present invention is not impaired, and preferably includes stainless steel, metal Ti (titanium), or a Ti alloy.

Even in a porous substrate sheet using a metal material, a stainless steel mesh (for example, SUS304, SUS316, SUS316L, and SUS340) is preferable. The thickness of the stainless steel mesh and the hole diameter, hole density, and size of the through-hole may be appropriately designed within a range in which the strength can be maintained without impairing the object of the present invention.

The stainless steel mesh may be self-made, or a commercially available product may be used.

The porous substrate sheet using the carbon material is preferably a carbon mesh. The carbon mesh is a mesh sheet including fibrous carbon and having a network structure including a void. The thickness of the carbon mesh and the hole diameter, hole density, and size of the through-hole may be appropriately designed within a range in which the strength can be maintained without impairing the object of the present invention.

The carbon mesh may be self-made, or a commercially available product may be used.

In the porous substrate sheet, a conductive material may be secured to the surface as necessary.

The microporous carbon layer is formed by applying a coating liquid containing a constituent component (MPL component) of the microporous carbon layer to the porous substrate sheet, and how the microporous carbon layer is formed depends not only on the MPL component but also on the structure and material of the porous substrate sheet. Since surface smoothness, permeability of the coating liquid into the mesh sheet, and the like change depending on a difference in the woven fabric structure of the mesh sheet, the mesh sheet may be appropriately selected according to the intended structure (structures (A) to (E)).

### (1-2. Microporous Carbon Layer)

In the gas diffusion composite material of the present invention, the microporous carbon layer contains a particulate and/or fibrous carbon material and a water-repellent resin. The microporous carbon layer has a pore size smaller than that of the porous substrate sheet described above, a high density, and excellent surface flatness. Thus, excellent electron conductivity can be achieved, and the contact resistance with the electrode catalyst layer or the separator can be reduced.

As the carbon material included in the microporous carbon layer, a particulate and/or fibrous carbon material is used. By having the microporous carbon layer containing these carbon materials, excellent conductivity can be imparted to the gas diffusion composite material of the present invention.

As the particulate carbon material, a known or commercially available one can be widely used. Examples thereof include carbon black such as Ketjen black and acetylene black; graphite; and activated carbon, and a single type thereof can be used alone or two or more types thereof can be used in combination. An average particle size of the particulate carbon material is usually about from 5 nm to 200 nm, preferably about from 20 to 80 nm.

By substituting a part of the particulate carbon material with the fibrous carbon material, the current collectability and gas diffusibility can be further enhanced.

As the fibrous carbon material, a known or commercially available one can be widely used. Examples thereof include carbon nanotubes (CNT), and carbon fibers (CF), and a single type thereof can be used alone or two or more types thereof can be used in combination.

The particulate and/or fibrous carbon material included in the microporous carbon layer is preferably carbon black, a carbon nanotube, and a mixture thereof.

As the water-repellent resin included in the microporous carbon layer, a fluorine-based resin can be used. Examples of the fluorine-based resin include a polytetrafluoroethylene resin (PTFE), a copolymer of tetrafluoroethylene and hexafluoropropylene (FEP), a copolymer of tetrafluoroethylene and perfluoropropyl vinyl ether (PFA), and a copolymer of tetrafluoroethylene and ethylene (ETFE), and a single type thereof can be used alone or two or more types thereof can be used in combination.

The ratio of the particulate and/or fibrous carbon material and the water-repellent resin included in the microporous carbon layer is determined within a range not impairing the object of the present invention.

One of the characteristics of the microporous carbon layer in the gas diffusion composite material of the present invention is that the microporous carbon layer can be formed using the same material as the MPL in a known gas diffusion layer with MPL. That is, by using the porous substrate sheet as a base, it is possible to form a gas diffusion member (so-called self-standing microporous layer) which has strength enough to maintain self-standing properties and is reduced in thickness to about the MPL (about 20 μm) in the gas diffusion layer with MPL without using a special carbon material.

The gas diffusion composite material for fuel cells of the present invention has a total thickness of 3 μm or more and 150 μm or less, preferably 5 μm or more and 100 μm or less, 20 μm or more and 100 μm or less, 5 μm or more and 60 μm or less, or 20 μm or more and 60 μm or less. Here, the “total thickness” is the total thickness of the porous substrate sheet and the microporous carbon layer. The total thickness can be measured by, for example, a micrometer.

### (1-3. Arrangement of Porous Substrate Sheet and Microporous Carbon Layer)

As described above, the gas diffusion composite material of the present invention has any one of the following structures (A) to (E).
Structure (A): a structure in which one surface of the porous substrate sheet is coated with the microporous carbon layer.
Structure (B): a structure in which both surfaces of the porous substrate sheet are coated with the microporous carbon layer.
Structure (C): a structure in which the microporous carbon layer covers one surface of the porous substrate sheet, and a part of the microporous carbon layer penetrates into the porous substrate sheet.
Structure (D): a structure in which the microporous carbon layer covers one surface of the porous substrate sheet, a part of the microporous carbon layer penetrates into the porous substrate sheet, and the microporous carbon layer reaches from one surface to the opposite surface of the porous substrate sheet.
Structure (E): a structure in which the entire porous substrate sheet is embedded in the microporous carbon layer.

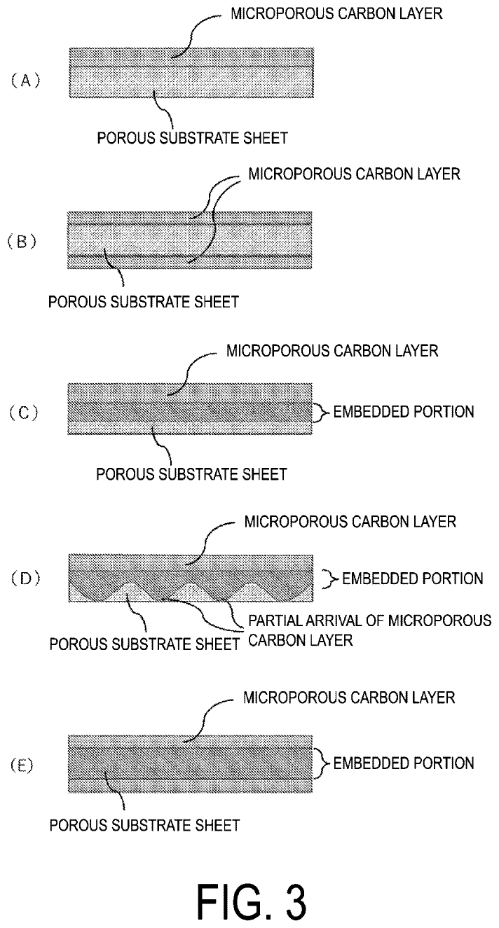

FIGS. 3(A) to 3(E) show the structures (A) to (E) of the gas diffusion composite material of the present invention, respectively.

When the gas diffusion composite material of the present invention has the structure (A) in which the microporous carbon layer shown in FIG. 3(A) covers one surface of the porous substrate sheet, the microporous carbon layer is usually disposed so as to be in contact with the electrode catalyst layer side, and the contact resistance between the electrode catalyst layer and the gas diffusion composite material is reduced. Also in the case of the structure (A), the microporous carbon layer may be disposed on the separator side, and in this case, the contact resistance between the separator and the gas diffusion composite material is reduced.

When the gas diffusion composite material of the present invention has the structure (B) in which the microporous carbon layer shown in FIG. 3(B) covers both surfaces of the porous substrate sheet, the microporous carbon layer is disposed so as to be in contact with both the electrode catalyst layer side and the separator side, and the contact resistance between the electrode catalyst layer and the gas diffusion composite material and the contact resistance between the separator and the gas diffusion composite material are reduced.

When the gas diffusion composite material of the present invention has the structure (C) in which the microporous carbon layer shown in FIG. 3(C) covers one surface of the porous substrate sheet, and a part of the microporous carbon layer penetrates into the porous substrate sheet, as in the case of the structure (A), the microporous carbon layer is usually disposed so as to be in contact with the electrode catalyst layer side, so that the contact resistance between the electrode catalyst layer and the gas diffusion composite material is reduced. Also in the case of the structure (C), the microporous carbon layer may be disposed on the separator side, and in this case, the contact resistance between the separator and the gas diffusion composite material is reduced.

In addition, as shown in FIG. 3(D), in the case of the structure (D) in which the microporous carbon layer covers one surface of the porous substrate sheet, and a part of the microporous carbon layer penetrates into the porous substrate sheet, and the microporous carbon layer reaches from one surface side to the opposite surface of the porous substrate sheet, the component (MPL component) contained in the microporous carbon layer exhibits excellent conductivity, so that the electrical resistance in the thickness direction of the gas diffusion composite material can be reduced.

When the porous substrate sheet is a mesh sheet, the difference in the woven fabric structure of the mesh sheet and a change in mesh diameter change the permeability of the coating liquid into the mesh sheet, and therefore, as in the structure shown in FIG. 3(D), the woven fabric structure, the pore size, and the like of the porous substrate sheet may be appropriately selected so that the MPL component becomes regular in the porous substrate sheet.

When the gas diffusion composite material of the present invention has the structure (E) in which the entire porous substrate sheet is embedded in the microporous carbon layer shown in FIG. 3(E), the microporous carbon layer is disposed so as to be in contact with both the electrode catalyst layer side and the separator side, and while the contact resistance between the electrode catalyst layer and the gas diffusion composite material and the contact resistance between the separator and the gas diffusion composite material are reduced, the component (MPL component) contained in the microporous carbon layer exhibits more excellent conductivity than the porous substrate sheet, so that the electrical resistance in the thickness direction of the gas diffusion composite material can be reduced.

When the gas diffusion composite material has the structure (D) or the structure (E), the component (MPL component) contained in the microporous carbon layer is continuous from one surface side to the opposite surface side of the porous substrate sheet, and exhibits conductivity derived from the microporous carbon layer, and therefore, a non-conductive porous substrate sheet (for example, a fluorine-based resin) can be used instead of the conductive porous substrate sheet (metal or carbon).

That is, other aspect of the present invention is a gas diffusion composite material for fuel cells, including: a porous substrate sheet including a non-conductive material; and a microporous carbon layer containing a particulate and/or fibrous carbon material and a water-repellent resin, wherein the porous substrate sheet has a thickness of 3 μm or more and 150 μm or less, and the gas diffusion composite material has the following structure (D) or (E).
Structure (D): a structure in which the microporous carbon layer covers one surface of the porous substrate sheet including the non-conductive material, a part of the microporous carbon layer penetrates into the porous substrate sheet including the non-conductive material, and the microporous carbon layer reaches from one surface to the opposite surface of the porous substrate sheet including the non-conductive material.
Structure (E): a structure in which the entire porous substrate sheet is embedded in the microporous carbon layer.

The thickness of the porous substrate sheet including a non-conductive material is 3 μm or more and 150 μm or less, and preferably 5 μm or more and 100 μm or less, or 5 μm or more and 50 μm or less. The total thickness is 3 μm or more and 150 μm or less, and preferably 5 μm or more and 100 μm or less, 20 μm or more and 100 μm or less, 5 μm or more and 60 μm or less, or 20 μm or more and 60 μm or less. With such a thickness, mechanical strength can be imparted to the gas diffusion composite material of the present invention, and self-standing properties can be provided even when the microporous carbon layer is provided. The thickness and the total thickness of the porous substrate sheet including a non-conductive material can be measured by, for example, a micrometer.

2. Components Other than Polymer Electrolyte Fuel Cell and Gas Diffusion Composite Material

In the polymer electrolyte fuel cell of the present invention, the above-described gas diffusion composite material for fuel cells (self-standing microporous layer) of the present invention is used as at least one of the gas diffusion composite materials disposed on the cathode side and the anode side.

As the gas diffusion composite material for fuel cells of the present invention, when the microporous carbon layer is provided on one surface side of the porous substrate sheet (structure (A), structure (C), and structure (D)), the gas diffusion composite material for fuel cells may be disposed such that one surface having the microporous carbon layer is in contact with the cathode catalyst layer and/or the anode catalyst layer, and the other surface having no microporous carbon layer is in contact with the separator, or such that one surface having the microporous carbon layer is in contact with the separator, and the other surface having no microporous carbon layer is in contact with the cathode catalyst layer and/or the anode catalyst layer.

As the gas diffusion composite material for fuel cells of the present invention, when the microporous carbon layers are provided on both sides of the porous substrate sheet (structure (B) and structure (E)), the gas diffusion composite material for fuel cells may be disposed such that one surface having the microporous carbon layer is in contact with the cathode catalyst layer and/or the anode catalyst layer, and the other surface having the microporous carbon layer is in contact with the separator.

With this arrangement, the surface having the microporous carbon layer comes into contact with both the electrode catalyst layer (cathode catalyst layer, anode catalyst layer) side and the separator side, and the contact resistance is reduced as compared with the case of using the gas diffusion composite material for fuel cells having the microporous carbon layer secured to one surface.

Hereinafter, components other than the gas diffusion composite material of the present invention in the polymer electrolyte fuel cell of the present invention will be described; however, since the components other than the gas diffusion composite material of the present invention are similar to known polymer electrolyte fuel cells, they will be briefly described.

A membrane electrode assembly (MEA) included in the polymer electrolyte fuel cell of the present invention includes a polymer electrolyte membrane, a cathode catalyst layer bonded to one surface of the polymer electrolyte membrane, and an anode catalyst layer bonded to the other surface of the polymer electrolyte membrane.

As the anode catalyst layer and the cathode catalyst layer, a known electrode catalyst layer (for example, an electrode catalyst layer formed from a carbon-based carrier supporting noble metal fine particles, an oxide carrier supporting noble metal fine particles, and the like) can be used, and thus a detailed description thereof is omitted.

As the polymer electrolyte membrane, any known electrolyte membranes for PEFC which are proton conductive, chemically stable, and thermal stable may be used. Examples of the electrolyte material forming the polymer electrolyte membrane include fluorine-based electrolyte materials and hydrocarbon-based electrolyte materials. In particular, an electrolyte membrane formed of a fluorocarbon electrolyte material is excellent in heat resistance, chemical stability, and the like, and thus is preferable.

As the separator, a known separator can be used, and examples thereof include a metal separator and a carbon separator.

In the polymer electrolyte fuel cell (unit cell) of the present invention, a fuel cell stack is formed by stacking by a cardinal number according to the power generation performance, and is assembled with other accompanying devices such as a gas supply device and a cooling device.

The embodiment of the present invention has been described above, but the embodiment disclosed herein is illustrative in all respects and is not restrictive. In particular, in the embodiment disclosed herein, values that can be easily conceived by those skilled in the art can be adopted for matters that are not explicitly disclosed, such as operating conditions of the fuel cell, various parameters, component dimensions, weights, volumes and the like without departing from the scope usually implemented by those skilled in the art.

### EXAMPLES

Hereinafter, the present invention will be described more specifically with reference to Examples, but the present invention is not limited thereto. In the following Examples, a gas diffusion composite member (MPL composite porous substrate sheet), a porous substrate sheet (not subjected to MPL combination), and a known gas diffusion layer (carbon fiber-based gas diffusion layer with MPL) are collectively referred to as “gas diffusion member”.

### <1. Gas Diffusion Member>

As the gas diffusion members 1 to 6, the following were used. The thickness of the gas diffusion member was measured five times with a micrometer (Mitutoyo Corporation, Coolant Proof Micrometer MDC-25MX), and calculated from the average thereof.

### Gas Diffusion Member 1: Stainless Steel Mesh (Porous Substrate Sheet)

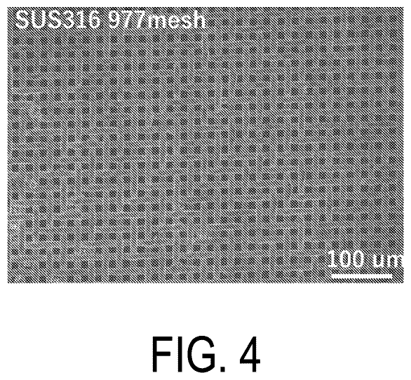

The Nilaco Corporation Stainless steel SUS316/wire mesh (977 mesh) was used. The stainless steel mesh sheet is formed of one layer of twill woven mesh, and a surface photograph of the gas diffusion member 1 (stainless steel mesh) is shown in FIG. 4 having a wire diameter φ of 13 μm and a thickness of 28 μm.

### Gas Diffusion Member 2: MPL Composite Stainless Steel Mesh (MPL Composite Porous Substrate Sheet)

According to the following procedure, an MPL composite stainless steel mesh as the gas diffusion member 2 was obtained.

To a mixed solvent of 300 μL (300 mg) of pure water and 1500 μL (1695 mg) of polyethylene glycol (PEG), 241 mg of highly graphitizable carbon black (GCB, Cabot Corporation, FCX200), 576 μL (CNT weight 30 mg) of a carbon nanotube dispersion liquid (Meijo Nano Carbon, MWNT INK), and 22.5 μL (PTFE weight 30 mg) of a water-repellent resin (DAIKIN INDUSTRIES, LTD., Polyflon PTFE D-210C) were added and mixed until the mixture became uniform, thereby obtaining a dispersion liquid for MPL formation.

The obtained dispersion liquid for MPL formation was screen-printed on a stainless steel mesh (gas diffusion member 1) using a screen (screen thickness: 30 μm). Screen printing was performed on a stainless steel mesh (gas diffusion member 1) cut slightly larger than a hole of the screen using a simple screen printing machine (available from RISO KAGAKU CORPORATION, PRINT GOKKO PG-11) to obtain a gas diffusion member 2 (MPL composite stainless steel mesh). The thickness of the gas diffusion member 2 was 62 μm.

Gas Diffusion Member 3: Carbon Fiber-Based Gas Diffusion Layer with MPL (Known Gas Diffusion Layer)

As a gas diffusion member 3, a commercially available gas diffusion layer with MPL 22BB (available from SGL Carbon, Germany, unit area mass 70 gm⁻²) including carbon paper having an MPL formed on a surface thereof was used. The thickness of the gas diffusion member 3 was 206 μm.

### Gas Diffusion Member 4: Carbon Mesh (Porous Substrate Sheet)

As the gas diffusion member 4, a carbon mesh (bias weave) available from Cosmotec Co., Ltd. was used. The thickness of the gas diffusion member 4 was 45 μm.

### Gas Diffusion Member 5: MPL Composite Carbon Mesh (MPL Composite Porous Substrate Sheet)

According to the following procedure, an MPL composite carbon mesh as the gas diffusion member 5 was obtained.

To a mixed solvent of 300 μL (300 mg) of pure water and 1500 μL (1695 mg) of PEG, 241 mg of GCB, a carbon nanotube dispersion liquid (CNT weight: 30 mg), and 22.5 μL (PTFE weight: 30 mg) of a water-repellent resin were added, and mixed until the mixture became uniform, thereby obtaining a dispersion liquid for MPL formation.

The obtained dispersion liquid for MPL formation was screen-printed on a carbon mesh (gas diffusion member 4) using a screen (screen thickness: 30 μm). Screen printing was performed on a carbon mesh (gas diffusion member 4) cut slightly larger than a hole of the screen using a simple screen printing machine (available from RISO KAGAKU CORPORATION, PRINT GOKKO PG-11) to obtain a gas diffusion member 5 (MPL composite carbon mesh). The thickness of the gas diffusion member 5 was 87 μm.

### Gas Diffusion Member 6: MPL Composite Carbon Mesh (MPL Composite Porous Substrate Sheet)

The gas diffusion member 6 (MPL composite carbon mesh) was obtained by the same method as the method for producing the gas diffusion member 5 except that 1400 μL (1400 mg) of pure water, 750 μL (847.5 mg) of PEG, 120.4 mg of GCB, 15 mg of CNT, and 7.12 mg of PTFE were used. The thickness of the gas diffusion member 6 was 87 μm.

### 2. Evaluation

### 2-1. Microstructure Observation

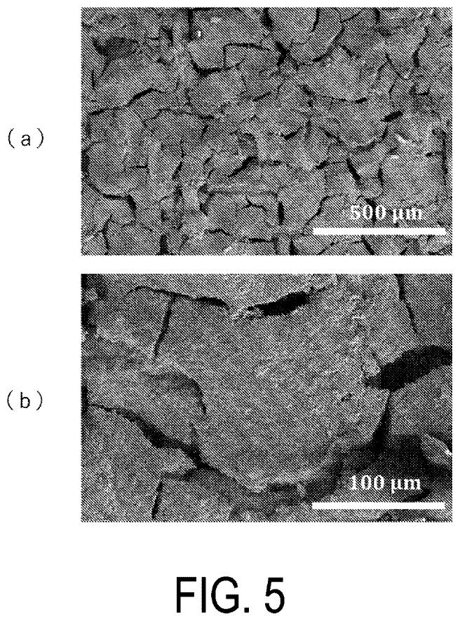

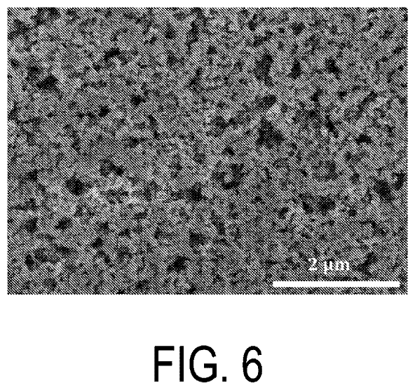

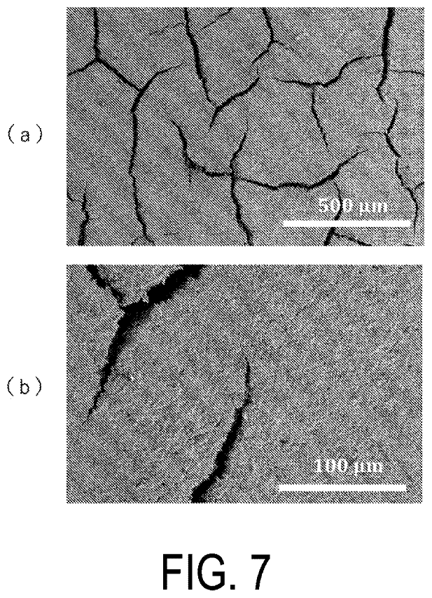

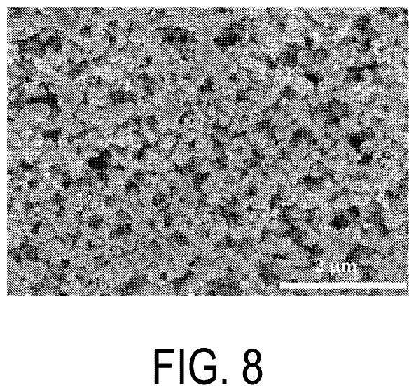

FIG. 5 is a surface SEM image and FIG. 6 is a cross-sectional SEM image of the gas diffusion member 2 (MPL composite stainless steel mesh). For reference, a surface SEM image and a cross-sectional SEM image of the gas diffusion member 3 (known gas diffusion layer with MPL) are shown in FIGS. 7 and 8, respectively.

FIG. 5 shows that, in the gas diffusion member 2 (MPL composite stainless steel mesh), the MPL was uniformly carried on the entire surface, which was similar to the gas diffusion member 3 (known gas diffusion layer with MPL) shown in FIG. 7. Cracks observed on the surface of the gas diffusion member 2 were determined to be cracks due to drying and curing of the material on the surface during heat treatment.

FIG. 6 shows that, in the gas diffusion member 2, the components were not separated also in the cross section, and the cross section was similar to the cross section of the gas diffusion member 3 shown in FIG. 8.

In the gas diffusion member 2, the MPL component was found not only on the surface but also on the back side.

From the above, the gas diffusion member 2 was determined to have the structure (D) (see FIG. 3) in which the MPL component penetrated into the mesh and the MPL component was continuously connected from the front surface to the back surface.

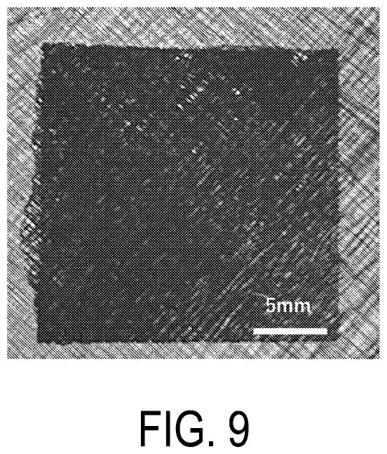

FIG. 9 is an appearance photograph of the gas diffusion member 5 (MPL composite carbon mesh).

FIG. 9 shows that the carbon mesh as a substrate was not found from the surface, and the MPL was uniformly retained on the surface. Since a part of the MPL component penetrated into the carbon mesh and did not reach the back surface, the gas diffusion member 5 was determined to have the structure (C) (see FIG. 3).

Similarly, with respect to the gas diffusion member 6 (MPL composite carbon mesh), the MPL was uniformly retained on the surface, and a part of the MPL component penetrated into the carbon mesh and did not reach the back surface; therefore, and thus, the gas diffusion member 6 was determined to have the structure (C) (see FIG. 3).

### 2-2. Electrochemical Evaluation (Unit Cell, Initial Performance Evaluation)

A PEFC (unit cell) having the following configuration was produced, and a power generation experiment (IV measurement) was performed.

### (Solid Electrolyte Membrane)

Nafion film (available from Du Pont, Nafion 212, thickness 51 μm)

### (Anode)

Electrode catalyst layer: Pt/C catalyst (available from TANAKA PRECIOUS METAL TECHNOLOGIES Co., Ltd.)
Gas diffusion layer: carbon fiber-based gas diffusion layer (carbon paper)

### (Cathode)

Electrode catalyst layer: Pt/C catalyst (available from TANAKA PRECIOUS METAL TECHNOLOGIES Co., Ltd.)
Gas diffusion layer: gas diffusion members 1 to 5

A unit cell power generation evaluation jig incorporating the gas diffusion members 1 to 5 was installed in a thermostatic chamber set at 80° C., and a power generation test was performed under the following conditions. A fuel cell evaluation apparatus (available from TOYO Corporation, model number: PE-8900K) and a potentio-galvanostat (available from Solartron Analytical, model number: SI1287) were used.

### (Anode Condition)

Electrode area: 1 cm²
Feed gas species: 100% H₂
Gas supply rate: 139 mL/min
Supply gas humidification temperature: 80° C. (relative humidity: 100%)

### (Cathode Condition)

Electrode area: 1 cm²
Feed gas species: Air
Gas supply rate: 332 mL/min
Supply gas humidification temperature: 80° C. (relative humidity: 100%)

### (Stainless Steel Mesh)

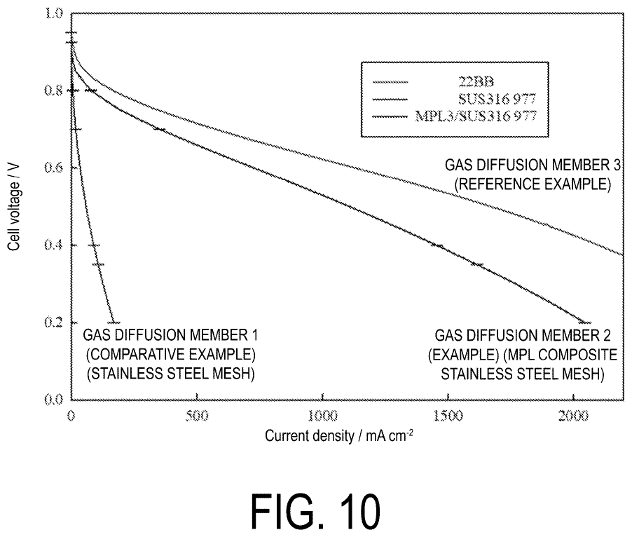

FIG. 10 is an evaluation result of current-voltage (IV) characteristics of the PEFC (unit cell) using the gas diffusion members 1 and 2. For reference, data of the unit cell using the gas diffusion member 3 (known gas diffusion layer with MPL) is also shown.

FIG. 10 shows that both the PEFCs using the gas diffusion members 1 and 2 were able to generate power, and the PEFC using the gas diffusion member 2 in which the MPL was combined had significantly improved IV characteristics as compared with the gas diffusion member 1 including no MPL. The gas diffusion member 2 exhibited performance comparable to that of the commercially available gas diffusion member 3 (known gas diffusion layer with MPL). In addition, the gas diffusion member 2 exhibited performance comparable to that of the gas diffusion member 3 in activation overvoltage and resistance overvoltage (not shown).

From the above, it was found that the power generation performance (IV characteristics) was improved by combining the stainless steel mesh and the MPL.

### (Carbon Mesh)

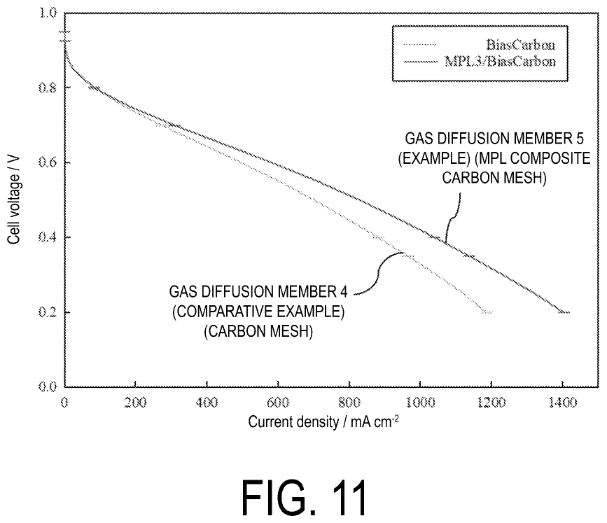

FIG. 11 is an evaluation result of the IV characteristics of the PEFC (unit cell) using the gas diffusion members 4 and 5.

FIG. 11 shows that both the PEFCs using the gas diffusion members 4 and 5 were able to generate power, and the PEFC using the gas diffusion member 5 in which the MPL was combined had improved IV characteristics as compared with the gas diffusion member 4 including no MPL.

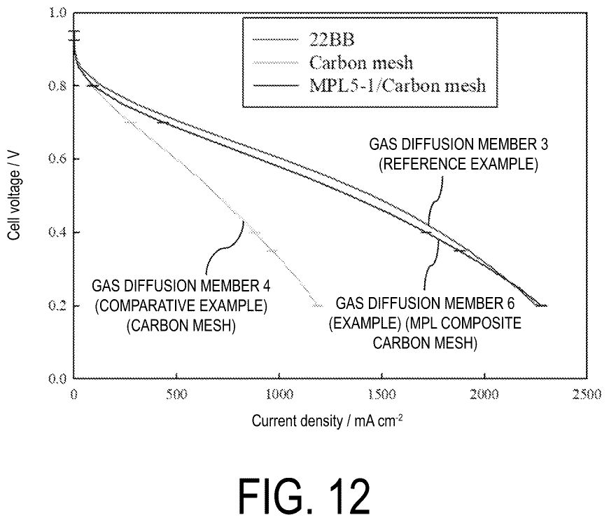

FIG. 12 is an evaluation result of the IV characteristics of the PEFC (unit cell) using the gas diffusion member 6.

FIG. 12 shows that the PEFC using the gas diffusion member 6 had improved IV characteristics as compared with the gas diffusion member 4 including no MPL, and exhibited performance comparable to that of the commercially available gas diffusion member 3 (known gas diffusion layer with MPL).

From the above, the power generation performance (IV characteristics) was found to be improved by combining the carbon mesh and the MPL.

### 2-3. Evaluation of Electrical Resistance and Electrical Resistivity

Various gas diffusion members each having a 1 cm square were sandwiched between two sheets of carbon paper (EC-TPI-060T, ElectroChem Inc., Raynhan MA, USA) having the same shape, and sandwiched between jigs for full cell evaluation to measure and evaluate electrical resistivity. First, the electrical resistances of various gas diffusion members were measured by electrochemical impedance (EIS) measurement using an electrochemical characteristic evaluation apparatus, and the electrical resistivity was calculated based on the thickness of the gas diffusion member. The inside of the apparatus was not humidified or heated, and any measurement was performed at normal temperature and normal pressure.

Table 1 shows the measurement result of the electrical resistance of each gas diffusion member (1×1 cm (1 cm²)), the thickness of each gas diffusion member, and the electrical resistivity calculated from the electrical resistance and the thickness. In Table 1, carbon paper (EC-TPI-060T, ElectroChem Inc., Raynhan MA, USA) commonly used as the gas diffusion layer is also shown as a reference example.

TABLE 1

| | | Microporous | Electrical | | Electrical |
|---|---|---|---|---|---|
| | Porous substrate | carbon layer | resistance | Thickness | resistivity |
| | sheet | (MPL) | (Ω) | (μm) | (Ω · cm) |
| Gas diffusion | Stainless steel mesh | — | 7.5 × 10⁻² | 28 | 26.79 |
| member 1 | (SUS316 977 mesh) | | | | |
| Gas diffusion | Stainless steel mesh | MPL | 1.8 × 10⁻² | 62 | 2.90 |
| member 2 | (SUS316 977 mesh) | combination | | | |
| Gas diffusion | Carbon paper | MPL surface | 9.5 × 10⁻³ | 206 | 0.46 |
| member 3 | | layer | | | |
| Gas diffusion | Carbon mesh | — | 1.4 × 10⁻² | 45 | 3.11 |
| member 4 | (Bias Carbon) | | | | |
| Gas diffusion | Carbon mesh | MPL | 1.3 × 10⁻² | 87 | 0.97 |
| member 5 | (Bias Carbon) | combination | | | |
| Reference | Carbon paper | — | 9.5 × 10⁻³ | 184 | 0.52 |
| Example | (EC-TPI-060) | | | | |

The comparison with the gas diffusion member 1 and the gas diffusion member 2, in both of which the porous substrate sheet is a stainless steel mesh, shows that the electrical resistivity is reduced to about 1/10 by the combination with the MPL. As described above, it was likely that, since the MPL component infiltrated to the back surface in the gas diffusion member 2, the conductivity was improved by the MPL component.

Also, the gas diffusion member 4 and the gas diffusion member 5, in both of which the porous substrate sheet was a carbon mesh, showed that the electrical resistivity was reduced by the combination with the MPL.

### INDUSTRIAL APPLICABILITY

The present invention is promising as a constituent member of a polymer electrolyte fuel cell used in automobiles such as passenger cars and commercial vehicles, electric power, gas, and household electric appliances.

1.-16. (canceled)

17. A gas diffusion composite material for fuel cells, the gas diffusion composite material comprising:
a porous substrate sheet including a conductive material; and
a microporous carbon layer containing a particulate and/or fibrous carbon material and a water-repellent resin,
wherein
the porous substrate sheet is a sheet-like member having a plurality of through-holes including a conductive material,
a material of the porous substrate sheet is a carbon material,
a form of the porous substrate sheet is a mesh sheet, a punching sheet, or an expanded sheet,
the porous substrate sheet has a thickness of 5 μm or more and 100 μm or less, and
the gas diffusion composite material has any one of the following structures (A) to (E):
structure (A): a structure in which one surface of the porous substrate sheet is coated with the microporous carbon layer,
structure (B): a structure in which both surfaces of the porous substrate sheet are coated with the microporous carbon layer,
structure (C): a structure in which the microporous carbon layer covers one surface of the porous substrate sheet, and a part of the microporous carbon layer penetrates into the porous substrate sheet, and the microporous carbon layer does not reach from the one surface to the opposite surface of the porous substrate sheet,
structure (D): a structure in which the microporous carbon layer covers one surface of the porous substrate sheet, a part of the microporous carbon layer penetrates into the porous substrate sheet, and the microporous carbon layer reaches from one surface to the opposite surface of the porous substrate sheet, and
structure (E): a structure in which the entire porous substrate sheet is embedded in the microporous carbon layer.

18. The gas diffusion composite material according to claim 17, wherein the porous substrate sheet has a thickness of 5 μm or more and 60 μm or less.

19. The gas diffusion composite material according to claim 17, wherein the porous substrate sheet is a carbon mesh.

20. The gas diffusion composite material according to claim 17, wherein the gas diffusion composite material has any one of the structures (C) to (E).

21. The gas diffusion composite material according to claim 17, wherein the gas diffusion composite material has the structure (C).

22. The gas diffusion composite material for fuel cells according to claim 17, wherein the particulate and/or fibrous carbon material included in the microporous carbon layer is carbon black, a carbon nanotube, and a mixture thereof.

23. A polymer electrolyte fuel cell comprising:
a membrane electrode assembly including a solid polymer electrolyte membrane, a cathode catalyst layer bonded to one surface of the solid polymer electrolyte membrane, and an anode catalyst layer bonded to the other surface of the solid polymer electrolyte membrane;
a pair of gas diffusion layers each stacked on a corresponding one of the cathode catalyst layer and the anode catalyst layer; and
a pair of separators sandwiching the membrane electrode assembly with the gas diffusion layer interposed therebetween,
wherein at least one of the pair of gas diffusion layers is the gas diffusion composite material according to claim 17.

24. A gas diffusion composite material for fuel cells, the gas diffusion composite material comprising:
a porous substrate sheet including a non-conductive material; and
a microporous carbon layer containing a particulate and/or fibrous carbon material and a water-repellent resin,
wherein
the porous substrate sheet has a thickness of 3 μm or more and 150 μm or less, and
the gas diffusion composite material has the following structure (D) or (E):
structure (D): a structure in which the microporous carbon layer covers one surface of the porous substrate sheet including the non-conductive material, a part of the microporous carbon layer penetrates into the porous substrate sheet including the non-conductive material, and the microporous carbon layer reaches from one surface to the opposite surface of the porous substrate sheet including the non-conductive material, and
structure (E): a structure in which the entire porous substrate sheet is embedded in the microporous carbon layer.

25. The gas diffusion composite material for fuel cells according to claim 24, wherein the particulate and/or fibrous carbon material included in the microporous carbon layer is carbon black, a carbon nanotube, and a mixture thereof.

26. A polymer electrolyte fuel cell comprising:
a membrane electrode assembly including a solid polymer electrolyte membrane, a cathode catalyst layer bonded to one surface of the solid polymer electrolyte membrane, and an anode catalyst layer bonded to the other surface of the solid polymer electrolyte membrane;
a pair of gas diffusion layers each stacked on a corresponding one of the cathode catalyst layer and the anode catalyst layer; and
a pair of separators sandwiching the membrane electrode assembly with the gas diffusion layer interposed therebetween,
wherein at least one of the pair of gas diffusion layers is the gas diffusion composite material according to claim 24.

27. A polymer electrolyte fuel cell comprising:
a membrane electrode assembly including a solid polymer electrolyte membrane, a cathode catalyst layer bonded to one surface of the solid polymer electrolyte membrane, and an anode catalyst layer bonded to the other surface of the solid polymer electrolyte membrane;
a pair of gas diffusion layers each stacked on a corresponding one of the cathode catalyst layer and the anode catalyst layer; and
a pair of separators sandwiching the membrane electrode assembly with the gas diffusion layer interposed therebetween,
wherein at least one of the pair of gas diffusion layers is the gas diffusion composite material according to claim 18.

28. A polymer electrolyte fuel cell comprising:
a membrane electrode assembly including a solid polymer electrolyte membrane, a cathode catalyst layer bonded to one surface of the solid polymer electrolyte membrane, and an anode catalyst layer bonded to the other surface of the solid polymer electrolyte membrane;
a pair of gas diffusion layers each stacked on a corresponding one of the cathode catalyst layer and the anode catalyst layer; and
a pair of separators sandwiching the membrane electrode assembly with the gas diffusion layer interposed therebetween,
wherein at least one of the pair of gas diffusion layers is the gas diffusion composite material according to claim 19.

29. A polymer electrolyte fuel cell comprising:
a membrane electrode assembly including a solid polymer electrolyte membrane, a cathode catalyst layer bonded to one surface of the solid polymer electrolyte membrane, and an anode catalyst layer bonded to the other surface of the solid polymer electrolyte membrane;
a pair of gas diffusion layers each stacked on a corresponding one of the cathode catalyst layer and the anode catalyst layer; and
a pair of separators sandwiching the membrane electrode assembly with the gas diffusion layer interposed therebetween,
wherein at least one of the pair of gas diffusion layers is the gas diffusion composite material according to claim 20.

30. A polymer electrolyte fuel cell comprising:
a membrane electrode assembly including a solid polymer electrolyte membrane, a cathode catalyst layer bonded to one surface of the solid polymer electrolyte membrane, and an anode catalyst layer bonded to the other surface of the solid polymer electrolyte membrane;
a pair of gas diffusion layers each stacked on a corresponding one of the cathode catalyst layer and the anode catalyst layer; and
a pair of separators sandwiching the membrane electrode assembly with the gas diffusion layer interposed therebetween,
wherein at least one of the pair of gas diffusion layers is the gas diffusion composite material according to claim 21.

31. A polymer electrolyte fuel cell comprising:
a membrane electrode assembly including a solid polymer electrolyte membrane, a cathode catalyst layer bonded to one surface of the solid polymer electrolyte membrane, and an anode catalyst layer bonded to the other surface of the solid polymer electrolyte membrane;
a pair of gas diffusion layers each stacked on a corresponding one of the cathode catalyst layer and the anode catalyst layer; and
a pair of separators sandwiching the membrane electrode assembly with the gas diffusion layer interposed therebetween,
wherein at least one of the pair of gas diffusion layers is the gas diffusion composite material according to claim 22.

32. A polymer electrolyte fuel cell comprising:
a membrane electrode assembly including a solid polymer electrolyte membrane, a cathode catalyst layer bonded to one surface of the solid polymer electrolyte membrane, and an anode catalyst layer bonded to the other surface of the solid polymer electrolyte membrane;
a pair of gas diffusion layers each stacked on a corresponding one of the cathode catalyst layer and the anode catalyst layer; and
a pair of separators sandwiching the membrane electrode assembly with the gas diffusion layer interposed therebetween,
wherein at least one of the pair of gas diffusion layers is the gas diffusion composite material according to claim 25.
